(19) United States
(12) Patent Application Publication
(10) Pub. No.: US 2022/0119228 A1
(43) Pub. Date: Apr. 21, 2022

(54) LIDAR LOADING SYSTEM

(71) Applicant: CASHMAN DREDGING AND MARINE CONTRACTING, CO., LLC, Quincy, MA (US)

(72) Inventors: Jay Cashman, Boston, MA (US); Timothy Mannering, Marshfield, MA (US); Aiden Horan, Waltham, MA (US)

(21) Appl. No.: 17/075,894

(22) Filed: Oct. 21, 2020

(51) Int. Cl. B66C 3/14; G01S 17/08; G01S 17/894; G01S 7/481; G06K 9/00; E02F 3/413; E02F 9/06

(52) U.S. Cl. CPC B66C 3/14; G01S 17/08; G01S 17/894; B66C 2700/0321; G06K 9/00805; E02F 3/4131; E02F 9/06; G01S 7/4817

(57) ABSTRACT

A loading system for a material has a grab dredger configured to selectively engage the material, where the grab dredger includes a boom and a line configured to move a grab throughout a working space. The working space includes an arc within a plane defined by a first dimension and a second dimension, where a third dimension lies perpendicular to the plane. The working space includes a minimum engagement distance and a maximum engagement distance. A Light Detection and Ranging (LiDAR) module can locate a material acquisition point, a material deposit point, and at least one obstacle point. A controller operates the grab dredger to move the grab within the working space to selectively engage the material. The loading system can move the material from the material acquisition point to the material deposit point while negotiating the at least one obstacle point.

### FIELD

The present technology relates to a loading system employing optical distance measuring, such as Light Detection and Ranging (LiDAR), to facilitate the relocation of one or more objects or materials, where a particular application includes a dredging operation.

### INTRODUCTION

This section provides background information related to the present disclosure which is not necessarily prior art.

Moving material between locations can be accomplished in various ways using many types of equipment. Various types of materials, including various objects, containers, packages, cargo, bulk materials, and environmental materials such as sand, earth, gravel, etc. can be relocated for shipping or receiving purposes, collection or harvesting purposes, or simply where such materials are moved from an undesired location to a desired location. When using various types of mechanized and/or powered equipment, an operator can guide and control the equipment to engage a material in order to relocate the material to a final destination or relocate the material within or on a transport that serves to further move the material to a remote location. Examples include the loading or unloading containers or materials to or from transport or storage locations as well as removal of materials, such as environmental materials, from an unwanted location.

Dredging is one particular operation of relocating or excavating an environmental material from a water environment. A dredging operation can employ a dredge, such as a mechanical dredge, that acquires material located within the water environment and relocates the material to a transport, such as a scow or barge. One example of a mechanical dredge includes a grab dredger that can grasp submerged material with a grab, such as a clam shell bucket, where the bucket can be suspended from a crane or a crane barge, carried by a hydraulic arm, or mounted on a dragline, for example. Dredging can be an important part of improving existing water features, reshaping land and water features to alter drainage, navigability, and/or commercial use, in construction of dams, dikes, and other controls for streams or shorelines, as well as in recovering or obtaining desirable submerged materials having commercial value.

Issues faced by an operator of mechanized or powered equipment, like a mechanical dredge, include locating the material to be engaged by the equipment and navigating the engaged material to a desired deposit location. Often the operating environment can present obstacles to locating the material to be engaged, moving the engaged material through the environment, and depositing the material in a particular desired location. Such obstacles can include obstacles to the line of sight of the operator, physical obstacles, as well as difficulties in estimating one or more locations, distances, and/or pathways between a point of acquiring material and a point of depositing material. Various locations can also change when moving material, as selectively engaging material, loading material, and/or unloading material can affect heights and/or positions of material and/or equipment, such as where drafts of a barge mounted mechanical dredge and/or scow can change when loaded or unloaded. These types of obstacles can hinder optimal and/or proper equipment use, whether by a human operator or by automated operation of the equipment.

Accordingly, there is a need for improved ways of acquiring material, moving the acquired material, and depositing the acquired material when one or more obstacles are present in the environment.

### SUMMARY

In concordance with the instant disclosure, the present technology includes systems and processes that relate to moving materials throughout a space.

Loading systems for a material are provided that include a material engagement means, a translation means, an optical distance measuring means, and a control means. The material engagement means can be configured to selectively engage the material. The translation means can be configured to move the material engagement means within a working space having three dimensions, the working space including a minimum engagement distance and a maximum engagement distance. The optical distance measuring means can be configured to locate a material acquisition point within the working space, to locate a material deposit point within the working space, and to locate at least one obstacle point located in a pathway between the material acquisition point and the material deposit point. The control means can be configured to operate the translation means to move the material engagement means within the working space and operate the material engagement means to selectively engage the material.

Various processes of using such loading systems to move a material are provided. In such methods, the material can be engaged with the material engagement means at the material acquisition point. The translation means can be used to move the material engagement means with the engaged material through the pathway to the material deposit point while negotiating the at least one obstacle point. The material can be disengaged with the material engagement means at the material deposit point. Embodiments include using the optical distance measuring means to locate one of the material deposit point, the at least one obstacle point, and the material deposit point and the at least one obstacle point upon engaging the material with the material engagement means at the material acquisition point. At this time, it is possible for the translation means to move from an unloaded position to a loaded position. Likewise, the optical distance measuring means can locate one of another material acquisition point, the at least one obstacle point, and another material acquisition point and the at least one obstacle point upon disengaging the material with the material engagement means at the material deposit point. At this time, it is possible for the translation means to move from a loaded position to an unloaded position and/or for the at least one obstacle point to move from an unloaded position to a loaded position.

In this way, the present systems and methods can account for changes in various locations, objects, and obstacles when moving material, as selectively engaging material, loading material, and/or unloading material can affect heights and/or positions of material and/or equipment when loaded or unloaded. Optimal pathways for moving material and negotiating one or more obstacles can provide efficient use of equipment use, whether by a human operator or by automated operation of the equipment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic elevational view of an embodiment of a loading system for moving material from a series of submerged locations to a scow to perform a dredging operation;

FIG. 2 is a schematic top plan view of the embodiment of the loading system of FIG. 1; and

FIG. 3 is a flowchart of an embodiment of a process for moving a material throughout a space.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology is drawn to loading systems and methods that can move material through an environment, including a changing environment, in an optimal fashion. A loading system for a material is provided that can include a material engagement means configured to selectively engage the material. A translation means can be included that is configured to move the material engagement means within a working space having three dimensions, the working space including a minimum engagement distance and a maximum engagement distance. An optical distance measuring means can be used to locate a material acquisition point within the working space, to locate a material deposit point within the working space, and to locate at least one obstacle point located in a pathway between the material acquisition point and the material deposit point. A control means can be configured to operate the translation means to move the material engagement means within the working space and operate the material engagement means to selectively engage the material.

The material engagement means can include various types of equipment. For example, the material engagement means can embody a grab, such as a grab having at least two jaws. Grabs include round nose grabs, clamshell grabs, and orange-peel grabs. Certain types of grabs include a clamshell bucket and an excavator bucket.

The translation means can include various types of equipment. Certain embodiments include where the translation means has a boom and a line coupled to the material engagement means. In this way, the boom and the line can move the material engagement means throughout the working space, where the working space can include an arc within a plane defined by a first dimension and a second dimension of the working space, and a third dimension of the working space lies perpendicular to the plane. In particular, the boom can swing throughout the arc and be raised and lowered to define a maximum arc path and a minimum arc path. The line can raise and lower the material engagement means in the third dimension lying perpendicular to the plane. In this way, the boom and the line together can define the working space. Other types of equipment can be employed as the translation means, including telescoping booms, articulated arms having various numbers and types of joints or pivot points, various configurations of cranes, etc. The translation means and the material engagement means, for example, can be comprised by a grab dredger, where the grab dredger can pick up submerged material with a clamshell bucket, which can hang from an onboard crane boom or crane barge, can be carried by a hydraulic arm, or can be mounted on a dragline. Certain embodiments include where the grab dredger is positioned onboard a barge.

The optical distance measuring means can have certain functionalities that can be performed by various types of equipment. Embodiments include where the optical distance measuring means is configured to determine a three-dimensional map of the pathway between the material acquisition point and the material deposit point. The optical distance measuring means can be configured to determine the three-dimensional map in real time. One example of the optical distance measuring means includes a Light Detection and Ranging (LiDAR) module. The optical distance measuring means can also locate the material acquisition point, the material deposit point, and/or the at least one obstacle point when the material engagement means selectively engages or disengages the material. In this way, an accurate position of the material acquisition point, the material deposit point, and/or the at least one obstacle point can be determined in response to any position changes in the system and/or environment that can result following engagement or disengagement of the material.

The control means can have certain functionalities that can be performed by various types of equipment. For example, the control means can be configured to operate the translation means to move the material engagement means within the working space and operate the material engagement means to engage and disengage the material according to a predetermined set of instructions. Where the translation means and the material engagement means are comprised by a grab dredger, the control means can operate a boom and a line coupled to a clamshell bucket. The control means can include manual controls for use by a human operator and/or automated controls for operation by a computer system including a processor and a non-transitory computer-readable storage medium. In certain embodiments, the control means can include a non-transitory computer-readable storage medium having encoded thereon one or more predetermined sets of instructions that, when executed by a computer, cause the computer to perform one or more methods or cycles of methods and/or method steps as described herein.

The loading systems and uses thereof can include certain combined functionalities. These include where the optical distance measuring means can be configured to determine a three-dimensional map of the pathway between the material acquisition point and the material deposit point in real time. In such cases, the optical distance measuring means can be configured to locate the material acquisition point, the material deposit point, and/or the at least one obstacle point when the material engagement means selectively engages or disengages the material. The control means can also be configured to operate the translation means to move the material engagement means within the working space and operate the material engagement means to engage and disengage the material according to a predetermined set of instructions.

Various methods of moving materials are provided, including where such methods can employ various loading systems, including the loading systems described herein. Uses of such loading systems to move a material include engaging the material with a material engagement means at a material acquisition point. A translation means can be used to move the material engagement means with the engaged material through a pathway to a material deposit point while negotiating at least one obstacle point. The material engagement means can disengage the material at a material deposit point.

Various effects, adjustments, and/or reactions can occur when operating loading systems and methods in moving a material. Certain embodiments include where upon engaging the material with the material engagement means at the material acquisition point, the optical distance measuring means can locate the material deposit point, the at least one obstacle point, or both the material deposit point and the at least one obstacle point. Consequently, upon engaging the material with the material engagement means at the material acquisition point, the translation means can move from an unloaded position to a loaded position. In a similar fashion, where upon disengaging the material with the material engagement means at the material deposit point, the optical distance measuring means can locate another material acquisition point, the at least one obstacle point, or both another material acquisition point and the at least one obstacle point. Disengaging the material with the material engagement means at the material deposit point can also result in where the translation means moves from a loaded position to an unloaded position. Upon disengaging the material with the material engagement means at the material deposit point, the at least one obstacle point can move from an unloaded position to a loaded position.

It is also possible to use three-dimensional mapping to assist in locating a material acquisition point, a material deposit point, and/or at least one obstacle point within a pathway between the material acquisition point and the material deposit point for a given working space. The optical distance measuring means can be used to determine a three-dimensional map of the pathway between the material acquisition point and the material deposit, thereby identifying a route to negotiate the material engagement means through the pathway and avoid any obstacles therein. The three-dimensional map can be determined in real time and the translation means can be used to move the material engagement means with the engaged material from the material acquisition point through the pathway to the material deposit point, as well as move the material engagement means from the material deposit point through the pathway to another material acquisition point.

As described, the optical distance measuring means can employ LiDAR technology for assisting an operator of a piece of machinery in moving an object from one location to another. LiDAR can be used to locate and to image objects. LiDAR can measure distances to a target by illuminating the target with laser light and measuring the reflected light with a sensor. Differences in laser return times and wavelengths can be used to make a digital three-dimensional representation of one or more targets, including mapping a working space and local environment thereof. A LiDAR unit or module can be in communication other portions of the systems described herein, including the control means as well as one or more display units used to show a representation of one or more material acquisition points, one or more material deposit points, one or more obstacle points, one or more pathways between the material acquisition point(s) and the material deposit point(s) for one or more working spaces. The LiDAR module can include a laser, a lens, and a sensor for receiving reflected laser light.

The LiDAR module can determine distance to a point of interest, target, or obstacle by recording a time between transmitted and backscattered laser pulses and by using the speed of light to calculate the distance traveled. It is possible to use the LiDAR module to create an accurate three dimensional map of an area of interest, such as the working space and a pathway between a given material acquisition point and a given material deposit point. The LiDAR module can also be used to scan and/or map areas outside of the working space and expected pathways. The rapid and accurate determination of distances and/or mapping of areas can replace mechanical measurements or estimates and can take the place of or complement the line of sight of a human operator. A number of LiDAR modules can be employed and positioned at various points within and around the system, such the LiDAR modules can be scalable by a person skilled in the art, to optimize optical distance measuring for a given loading system configuration. For example, one or more LiDAR modules can be configured to project laser beams within a 180° horizontal field of view (FOV) or one or more LiDAR modules can project laser beams within a 360° horizontal FOV. It should be appreciated that the field of view of the LiDAR module can be adjusted according to the given position and application.

In certain embodiments, the LiDAR module is a VELODYNE® PUCK™ available from Velodyne (San Jose, Calif.). The PUCK™ includes sixteen (16) channels with a range of 100 meters. The PUCK™ can be capable of generating up to 600,000 points per second, across a 360° horizontal FOV and a 30° FOV. The rotations per minute of laser can be adjusted to increase or decrease the amount of points obtained by the PUCK™. It should be appreciated that although the VELODYNE® PUCK™ has been shown to be useful, other LiDAR modules can be employed.

Loading systems for materials and uses thereof can be adapted for a variety of tasks, including moving various types of materials, including various objects, containers, packages, cargo, bulk materials, and environmental materials such as sand, earth, gravel, etc., where such materials can be moved or relocated for shipping or receiving purposes, collection or harvesting purposes, or where such materials are moved from an undesired location to a desired location. Certain applications of the loading systems and uses thereof are especially beneficial in dredging operations, where material is to be excavated underwater and loaded onto a scow or barge. As the material is engaged by a mechanical dredge, for example, and deposited onto the scow, the draft of the mechanical dredge (e.g., positioned on a barge) and the draft of the scow can change. Here, the optical distance measuring means (e.g., LiDAR module) can image the real time location and elevation of the barge and/or scow along with the material. The system can also alert an operator if the material engagement means (including engaged material) that is being moved to the scow is not at a sufficient height or placement and may contact one or more obstacles within the travel path. Examples of such obstacles include the side of the scow, the side of a material holding area on the scow, a portion of a barge on which the mechanical dredge is positioned, various environmental obstacles, including pilings, other vessels, buoys, etc. In this way, undesired contact and/or damage can be minimized while at the same time pathway distances can still be minimized (e.g., preventing greater than necessary travel pathways that overcompensate for clearance issues) in order to maximize material movement efficiency and time savings. The optical distance measuring means (e.g., LiDAR module) can be integrated into an automation sequence, optionally along with the use of other sensors, to automate movement of material that involves a series of repetitive steps or operations.

Additional examples of loading systems for materials and uses thereof include where the optical distance measuring means (e.g., LiDAR module) is used in conjunction with loading of a vessel with material/cargo. The LiDAR module can image the outline of the vessel and aid in the placement of material/cargo onto the vessel by a second vessel such as a dredge, landside excavator, crane, conveyor, or similar equipment. Without the present technology, the equipment operator has to rely upon skill, experience, and human perception to move material/cargo onto vessels. This includes swinging a material engagement means over the sides of the vessel or other obstacles that may be present. The present systems can methods utilize optical distance measuring to significantly aid the equipment operator in loading the vessel and moving material in a controlled and efficient manner by providing feedback on the locations of obstacles within the environment that can be in the way of the loading workspace or pathway.

Loading systems and uses thereof, as provided herein, can be configured to operate in various configurations of equipment. That is, various types of material engagement means, translation means, optical distance measuring means, and control means can be implemented. One example includes where the loading system is configured as a floating crane used for placing/removing materials/cargo on another separate floating piece of equipment. Another example includes a floating crane used for placing/removing materials/cargo onto land. Yet another example includes a floating crane used for manipulating material/cargo on another, separate floating piece of equipment. Still another example includes a floating crane used for manipulating material/cargo on the same piece of equipment on which the crane is mounted. A further example includes a floating crane used for manipulating material/cargo on land. Yet a further example includes a land crane used for manipulating material/cargo on a floating piece of equipment. Still a further example includes a land crane used for manipulating material/cargo on a land-based piece of equipment. Another example includes a land crane used for manipulating material/cargo on land.

The loading system use thereof can be complimented with additional optical distance measuring means (e.g., LiDAR modules) and sensors placed in the vicinity of the material engagement means and translation means (e.g., a crane configured with a boom, line, and grab) in order to develop a more complete image of the working space, environment, or pathway(s) or for instances when a portion of the operation can be out of view of the equipment operator; e.g., where material/cargo is moved into or out of deep shafts or deep draft vessels.

Certain aspects of the loading systems and uses thereof can include automating movement of certain materials. In automation, a function of the system can include detection of horizontal and vertical locations of a material acquisition point, a material deposit point, and at least one obstacle point located in a pathway between the material acquisition point and the material deposit point. For example, where a scow is present, automated controls can navigate a material engagement means (e.g., clamshell bucket) over or past any obstacle and remove or release the material/cargo into the scow without contact with the scow itself. The optical distance measuring means (e.g., LiDAR module) can also image the previously placed material within the scow to create a real time surface of material contained within the scow to assist where additional material should be deposited to achieve correct and efficient loading of the scow, including the balancing of material loads and efficient utilization of available space.

Various types of notifications can be provided by the loading systems during use. In particular, where the optical distance measuring means locates certain desired points or maps an area, the optical distance measuring means can image the area and provide an auditory and/or visual notification, alarm, or provide an automatic stop when a potential impact is detected between the material engagement means and an object or structure within a pathway between a given material acquisition point and a given material deposit point. To this end, the optical distance measuring means can include one or more LiDAR modules mounted at various locations advantageous to allow line of sight for the following: inside the scow, a representation of the scow, barge, or other vessel combings or any other physical obstructions that keep material inside the scow, material to be moved, material that has already been moved, a water surface (e.g., used for referencing elevation). As previously mentioned, additional LiDAR sensors may be utilized to develop a more complete image of the working space and surrounding environment where such additional imaging can prove advantageous to a particular equipment configuration or task.

The present technology provides benefits and advantages in moving material in many contexts. Examples of such contexts include: marine construction, dredging, deep hole excavation, offshore wind turbine installation or modification, jetty/breakwater construction, land reclamation, port operations, loading and offloading of cargo materials of any type from vessels, loading and offloading of cargo materials of any type to haulage vehicles, automating repetitive loading/unloading cycles of vessels, general construction, hoisting construction materials of any type, use in situations where the operator of a loading system is faced with an obstructed view, and automating of repetitive hoisting operations.

### EXAMPLES

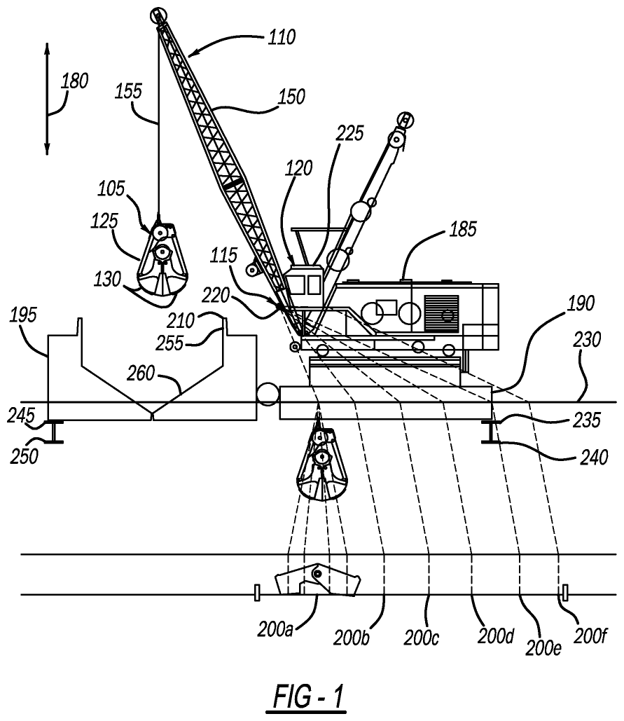

Example embodiments of the present technology are provided with reference to FIGS. 1-3 enclosed herewith.

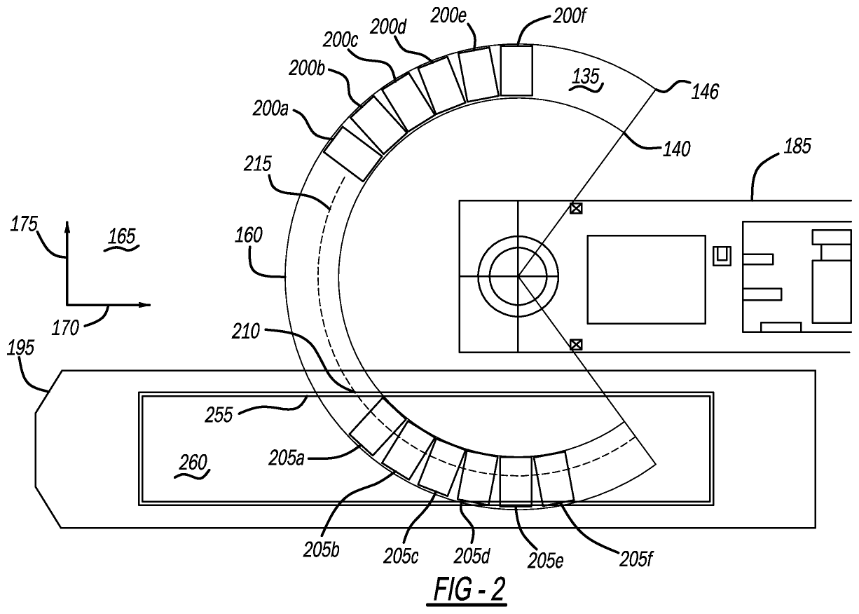

With reference to FIGS. 1 and 2, operation of an embodiment of a loading system 100 for a material in accordance with the present technology is shown. The loading system 100 includes a material engagement means 105, a translation means 110, an optical distance measuring means 115, and a control means 120. The material engagement means 105 is configured to selectively engage the material, where the material engagement means 105 is depicted as a clamshell bucket 125 having two jaws 130.

The translation means 110 is configured to move the material engagement means 105 within a working space 135 having three dimensions, where the working space 135 includes a minimum engagement distance 140 and a maximum engagement distance 145. In the embodiment depicted, the translation means 110 includes a boom 150 and a line 155 coupled to the material engagement means 105. The boom 150 and the line 155 are configured to move the material engagement means 105 throughout the working space 135, where in the embodiment depicted, the working space 135 includes an arc 160 within a plane 165 defined by a first dimension 170 and a second dimension 175 (see FIG. 1) of the working space 135. A third dimension 180 of the working space 135 lies perpendicular to the plane 165 (see FIG. 2).

As shown, the material engagement means 105 and the translation means 110 are comprised by a grab dredger 185. The embodiment of the grab dredger 185 depicted is positioned onboard a barge 190. Within a working proximity of the grab dredger 185 is a scow 195 for depositing material therein.

The optical distance measuring means 115 is configured to locate a material acquisition point 200a-f within the working space 135, to locate a material deposit point 205a-f within the working space 135, and to locate at least one obstacle point 210 located in a pathway 215 between the material acquisition point 200a-f and the material deposit point 205a-f. In the embodiment depicted, the optical distance measuring means 115 includes a LiDAR module 220 mounted to the grab dredger 185. However, as noted herein, it is possible to mount multiple LiDAR modules 220 throughout the system 100, including at various positions on the grab dredger 185 as well as the barge 190 and/or the scow 195.

The system 100 can use the optical distance measuring means 115 to determine a three-dimensional map of the pathway 215 between the material acquisition point 200a-f and the material deposit point 205a-f. In particular, the LiDAR module 220 of the optical distance measuring means 115 can determine the three-dimensional map in real time. It therefore possible for the optical distance measuring means 115 to ascertain the material acquisition point 200a-f, the material deposit point 205a-f, and/or the at least one obstacle point 210 relative to each other as well as relative to a three-dimensional map of the working space 135, as desired. These various points can be located before, during, and/or after the material engagement means 105 selectively engages or disengages the material. In this way, the system 100 can respond to changing conditions (e.g., loaded and unloaded states) that can change the location of various points relative to each other (e.g., draft of the barge 190 on which the grab dredger 185 is mounted, draft of the scow 195).

The control means 120 is configured to operate the translation means 110 to move the material engagement means 105 within the working space 135 and operate the material engagement means 105 to selectively engage the material. As shown in the figures, the control means 120 can be positioned within an operator compartment 225 of the grab dredger 185. It is understood, however, that the control means 120 can also be positioned remotely from the grab dredger 185 and the present technology includes embodiments where the control means 120 can be wireless or operated wirelessly from various positions of the system 100 or remote from the system 100. For example, a human operator can use the control means 120 to operate the system 100 from the operator compartment 225. It is also possible to have the control means 120 operate the translation means 110 to move the material engagement means 105 within the working space 135 and operate the material engagement means 105 to engage and disengage the material according to a predetermined set of instructions, whether fully autonomously or partially autonomously with input from the human operator. For example, material movement for a series of six material acquisition points 200a-f and a series of six material deposit points 205a-f can be automated, where the at least one obstacle point 210 is automatically negotiated based upon constantly updated real-time conditions by the optical distance measuring means 115.

The loading system 100 can be used in various ways to move a material. Generally, the material engagement means 105 (e.g., the clamshell bucket 125 having two jaws 130) engages the material at one or more respective material acquisition points 200a-f. In the embodiment depicted, the system 100 includes the grab dredger 185 positioned onboard a barge 190, where in working proximity, the scow 195 is positioned for depositing the material therein. The material in the embodiment shown can include sediment located below a waterline 230. The translation means 110 (e.g., the boom 150 and the line 155) moves the material engagement means 105 with the engaged material through the pathway 215 to one or more respective material deposit points 205a-f while negotiating the at least one obstacle point 210. The material engagement means 105 then disengages the material at the respective material deposit point 205a-f. The engaging, moving, and disengaging operations can be repeated as desired. In the embodiment depicted in the figures, six cycles are shown for moving material from the respective six material acquisition points 200a-f to the respective six material deposit points 205a-f. It should be noted that successive engaging, moving, and disengaging operations can be spaced apart and/or can be performed on substantially repeat points or locations.

Upon engaging the material with the material engagement means 105 at the material acquisition point 200a-f, the optical distance measuring means 115 can locate the material deposit point 205a-f and/or the at least one obstacle point 210. Furthermore, upon engaging the material with the material engagement means 115 at the material acquisition point 200a-f, the translation means 110 can move from an unloaded position 235 to a loaded position 240. As shown in the embodiment depicted in FIG. 1, the translation means 110 is part of the grab dredger 185, where the draft of the grab dredger 185 changes from the unloaded position 235 to the loaded position 240 upon engaging the material due at least in part to the extra weight of the material on the grab dredger 185 barge 190. In a similar fashion, upon disengaging the material with the material engagement means 115 at the material deposit point 205a-f, the optical distance measuring means 115 can locate another material acquisition point 205a-f and/or the at least one obstacle point 210. Upon disengaging the material with the material engagement means 115 at the material deposit point 205a-f, it is possible for the translation means 110 to move from the loaded position 240 to the unloaded position 235, where the draft of the grab dredger 185 changes from the loaded position 240 to the unloaded position 235 upon disengaging the material due at least in part to removal of the extra weight of the material on the grab dredger 185 barge 190. Likewise, upon disengaging the material with the material engagement means 105 at the material deposit point 205a-f, the at least one obstacle point 210 can move from an unloaded position 245 to a loaded position 250, where the draft of the scow 195 changes from the unloaded position 245 to the loaded position 250 due at least in part to the extra weight of the material on the scow 195. As shown, a side 255 of a holding area 260 of the scow 195 can comprise the at least one obstacle point 210, which can change in location relative to the change in draft of the scow 195 between the unloaded position 245 and the loaded position 250. Further loading or unloading of the scow 195 can result in further changes.

The optical distance measuring means 115 can be used to determine a three-dimensional map of the pathway 215 between the material acquisition point 200a-f and the material deposit point 205a-f. Determination of the three-dimensional map can occur in real time and can be used to determine changes in the environment before, during, and after material movement. In particular, using the translation means 110 to move the material engagement means 105 with the engaged material through the pathway 215 to the material deposit point 205a-f while negotiating the at least one obstacle point 210 can account for the three-dimensional map of the pathway 215 as determined in real time. This allows for any changes in the environment and updates relative to the efficient movement of material, including accounting for where the draft of the grab dredger 185 changes between the unloaded position 235 and the loaded position 240, where the draft of the scow 195 changes between the unloaded position 245 and the loaded position 250, and/or the side 255 of a holding area 260 of the scow 195 including the at least one obstacle point 210 changes in location relative to any change in draft of the scow 195.

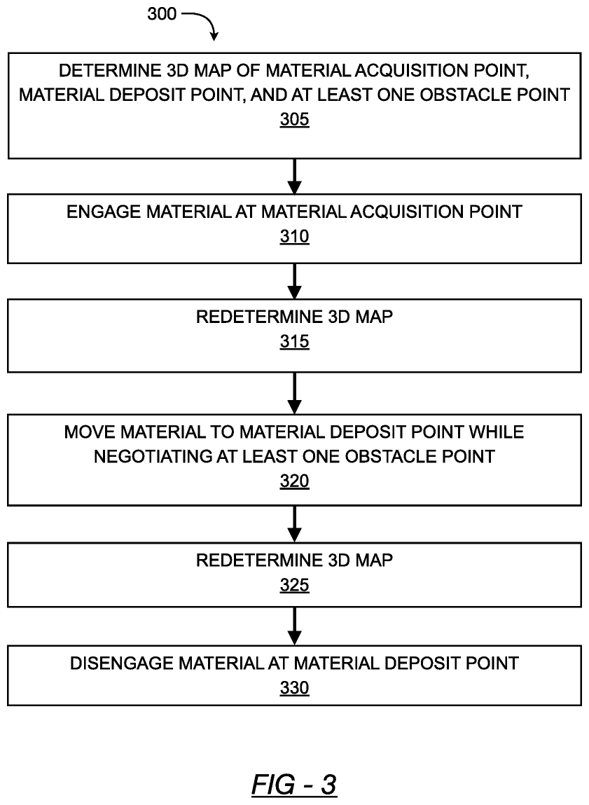

With reference to FIG. 3, an embodiment of a process for moving a material throughout a space in accordance with the present technology is provided at 300. It should be appreciated that the process 300 can be performed using various embodiments of loading systems for materials, including the loading system 100 for a material as shown in FIGS. 1-2. Likewise, the process 300 can include additional aspects, steps, and operations as already described herein. The process 300 can initiate with the determination of a three-dimensional (3D) map that includes a material acquisition point, a material deposit point, and one or more obstacle points, as indicated at 305. A material can then be engaged at the material acquisition point, as indicated at 310. It is then possible to redetermine the 3D map, at 315, where the 3D map can include one or more of the material acquisition point, the material deposit point, and obstacle point(s). For example, engagement of the material can change a position or draft of a material engagement means employed in the process or can change a position or draft of the material acquisition point. The engaged material can then be moved to the material deposit point while one or more obstacle points are negotiated, as per 320. It should be appreciated, however, that certain instances may not require negotiating any obstacle(s) a pathway between the material acquisition point and the material deposit point in the working space. Once the material is moved to the material deposit point, the 3D map can be redetermined, as per 325. It should be understood, however, the determination of the 3D map and the various redeterminations of the 3D map, indicated at 305, 315, and 325, can be replaced by real-time or continuous determination of the 3D map throughout the process, as opposed to discrete 3D map determinations. The material can then be disengaged at the material deposit point, as shown at 330, where the process can be repeated to move additional material, as desired. Different material acquisition points can be selected as can different material deposit points, with respective determination(s) of new or repositioned obstacle(s) in subsequent pathways between the respective material acquisition points and material deposit points. In this way, optimal pathways can be determined for moving material and negotiating one or more obstacles, thereby allowing efficient use of equipment, whether by a human operator or by automated operation of the equipment.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A loading system for a material, comprising:
a material engagement means configured to selectively engage the material;
a translation means configured to move the material engagement means within a working space having three dimensions, the working space including a minimum engagement distance and a maximum engagement distance;
an optical distance measuring means configured to locate a material acquisition point within the working space and to locate a material deposit point within the working space; and
a control means configured to operate the translation means to move the material engagement means within the working space and operate the material engagement means to selectively engage the material.

2. The loading system of claim 1, wherein the material engagement means includes a grab having at least two jaws.

3. The loading system of claim 1, wherein the translation means includes a boom and a line coupled to the material engagement means, the boom and the line configured to move the material engagement means throughout the working space, the working space including an arc within a plane defined by a first dimension and a second dimension of the working space, where a third dimension of the working space lies perpendicular to the plane.

4. The loading system of claim 1, wherein the material engagement means and the translation means are comprised by a grab dredger.

5. The loading system of claim 4, wherein the grab dredger is positioned onboard a barge.

6. The loading system of claim 1, wherein the optical distance measuring means is configured to determine a three-dimensional map of a pathway between the material acquisition point and the material deposit point.

7. The loading system of claim 6, wherein the optical distance measuring means is configured to determine the three-dimensional map in real time.

8. The loading system of claim 1, wherein the optical distance measuring means includes a Light Detection and Ranging (LiDAR) module.

9. The loading system of claim 1, wherein the optical distance measuring means is configured to locate a member selected from a group consisting of the material acquisition point, the material deposit point, and combinations thereof, when the material engagement means selectively engages or disengages the material.

10. The loading system of claim 1, wherein the control means is configured to operate the translation means to move the material engagement means within the working space and operate the material engagement means to engage and disengage the material according to a predetermined set of instructions.

11. The loading system of claim 1, wherein the optical distance measuring means is configured to locate at least one obstacle point located in a pathway between the material acquisition point and the material deposit point.

12. The loading system of claim 11, wherein the optical distance measuring means is configured to locate a member selected from a group consisting of the material acquisition point, the material deposit point, the at least one obstacle point, and combinations thereof, when the material engagement means selectively engages or disengages the material.

13. The loading system of claim 11, wherein:
the optical distance measuring means is configured to determine a three-dimensional map of the pathway between the material acquisition point and the material deposit point in real time;
the optical distance measuring means is configured to locate a member selected from a group consisting of the material acquisition point, the material deposit point, the at least one obstacle point, and combinations thereof, when the material engagement means selectively engages or disengages the material; and
the control means is configured to operate the translation means to move the material engagement means within the working space and operate the material engagement means to engage and disengage the material according to a predetermined set of instructions.

14. A loading system for a material, comprising:
a grab dredger configured to selectively engage the material, the grab dredger including a boom, a line, and a grab, wherein the boom and the line are configured to move the grab throughout a working space, the working space including an arc within a plane defined by a first dimension and a second dimension of the working space, where a third dimension of the working space lies perpendicular to the plane, the working space including a minimum engagement distance and a maximum engagement distance;
a Light Detection and Ranging (LiDAR) module configured to locate a material acquisition point within the working space, to locate a material deposit point within the working space, and to locate at least one obstacle point located in a pathway between the material acquisition point and the material deposit point; and
a controller configured to operate the grab dredger to move the grab within the working space and operate the grab to selectively engage the material.

15. A method of moving a material, comprising:
providing a loading system comprising:
a material engagement means configured to selectively engage the material;
a translation means configured to move the material engagement means within a working space having three dimensions, the working space including a minimum engagement distance and a maximum engagement distance;
an optical distance measuring means configured to locate a material acquisition point within the working space and to locate a material deposit point within the working space; and
a control means configured to operate the translation means to move the material engagement means within the working space and operate the material engagement means to selectively engage the material;
engaging the material with the material engagement means at the material acquisition point;
using the translation means to move the material engagement means with the engaged material through the pathway to the material deposit; and
disengaging the material with the material engagement means at the material deposit point.

16. The method of claim 15, wherein upon engaging the material with the material engagement means at the material acquisition point, the translation means moves from an unloaded position to a loaded position.

17. The method of claim 15, wherein upon disengaging the material with the material engagement means at the material deposit point, the translation means moves from a loaded position to an unloaded position.

18. The method of claim 15, further comprising determining a three-dimensional map of the pathway between the material acquisition point and the material deposit point using the optical distance measuring means.

19. The method of claim 15, wherein the optical distance measuring means is configured to locate at least one obstacle point located in a pathway between the material acquisition point and the material deposit point.

20. The method of claim 19, wherein using the translation means to move the material engagement means with the engaged material through the pathway to the material deposit point includes negotiating the at least one obstacle point.

21. The method of claim 19, wherein upon engaging the material with the material engagement means at the material acquisition point, the optical distance measuring means locates one of the material deposit point, the at least one obstacle point, and the material deposit point and the at least one obstacle point.

22. The method of claim 19, wherein upon disengaging the material with the material engagement means at the material deposit point, the optical distance measuring means locates one of another material acquisition point, the at least one obstacle point, and another material acquisition point and the at least one obstacle point.

23. The method of claim 19, wherein upon disengaging the material with the material engagement means at the material deposit point, the at least one obstacle point moves from an unloaded position to a loaded position.

24. The method of claim 19, further comprising:
determining a three-dimensional map of the pathway between the material acquisition point and the material deposit point using the optical distance measuring means, wherein the three-dimensional map is determined in real time; and
using the translation means to move the material engagement means with the engaged material through the pathway to the material deposit point while negotiating the at least one obstacle point accounts for the three-dimensional map of the pathway as determined in real time.
